(19) United States
(12) Patent Application Publication
(10) Pub. No.: US 2017/0192199 A1
(43) Pub. Date: Jul. 6, 2017

(54) ATTACHABLE LENS MODULE

(71) Applicant: Samsung Electro-Mechanics Co., Ltd., Suwon-si (KR)

(72) Inventor: Hwan Soo PARK, Suwon-si (KR)

(73) Assignee: Samsung Electro-Mechanics Co., Ltd., Suwon-si (KR)

(21) Appl. No.: 15/370,175

(22) Filed: Dec. 6, 2016

(30) Foreign Application Priority Data
Jan. 4, 2016 (KR) 10-2016-0000316

(51) Int. Cl. G02B 7/14; H04M 1/02; H04N 5/225

(52) U.S. Cl. CPC G02B 7/14; H04N 5/2254; H04M 1/0264

(57) ABSTRACT

An attachable lens module includes: a housing including an internal space; a fixed lens group mounted in the internal space and including a lens aligned on an optical axis of the lens module; and a moving lens group comprising a moving lens, and configured to move along a guide rail mounted in the housing to be aligned with the fixed lens group on the optical axis.

### CROSS-REFERENCE TO RELATED APPLICATIONS

This application claims the benefit under 35 USC 119(a) of Korean Patent Application No. 10-2016-0000316 filed on Jan. 4, 2016 in the Korean Intellectual Property Office, the entire disclosure of which is incorporated herein by reference for all purposes.

### BACKGROUND

1. Field

The following description relates to an attachable lens module.

2. Description of Related Art

In recent years, as smartphones and tablet PC's have become widely popular, a camera module mounted in portable terminals such as the smartphone or the tablet PC has replaced a portable camera (for example, a stand-alone digital camera). Accordingly, users have taken it for granted that a high-end camera is mounted in the portable terminal.

One difficulty of mounting high-end cameras in portable terminals is that a space in which the camera module is to be mounted may be insufficient, due to the portable terminal having a slim form. Therefore, there may not be a sufficient number of optical systems embedded in the camera module to provide high-end performance. As a result, there may be a limitation in increasing the number of pixels of the camera module. For this reason, attachable lens modules for a portable terminal, as well as for a portable camera (digital camera, or the like) have been developed.

However, a user needs to carry the attachable lens module separately from a portable camera, which causes a new inconvenience to users. Therefore, there is a desire to considerably reduce this inconvenience.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, an attachable lens module includes: a housing including an internal space; a fixed lens group mounted in the internal space and including a lens aligned on an optical axis of the lens module; and a moving lens group including a moving lens, and configured to move along a guide rail mounted in the housing to be aligned with the fixed lens group on the optical axis.

The moving lens group may be configured to move from a position in which the moving lens group is horizontally spaced from the fixed lens group to a position in which the moving lens group is disposed on the optical axis.

The moving lens group may be configured to move in one of an object side direction of the fixed lens group and an upper side direction of the fixed lens group, from a position in which the moving lens group is horizontally spaced from the fixed lens group, to be aligned with the fixed lens group on the optical axis.

The guide rail may include an oblique rail disposed in a direction inclined with respect to the optical axis. The moving lens group may be configured to move from a position in which the moving lens group is horizontally spaced from the fixed lens group to a position in which the moving lens group is aligned with the fixed lens group on the optical axis.

The guide rail may include a first straight rail connected to the oblique rail at a position aligned with an end portion of the fixed lens group. The moving lens group may be aligned in parallel with the fixed lens group when positioned at the first straight rail.

The guide rail may further include a second straight rail connected to the oblique rail at a position spaced from the end portion of the fixed lens group in a horizontal direction perpendicular to the optical axis. The moving lens group may be aligned in parallel with the fixed lens group when positioned at the straight rail.

The guide rail may be mounted on an inner side surface of the housing and may include a groove. The moving lens group may include a protrusion-shaped moving guide part configured to move while fitted in the guide rail.

The guide rail may be mounted on an inner side surface of the housing in a protrusion shape. The moving lens group may include a moving guide part mounted in a groove configured to move while the guide rail is fitted in the groove.

The housing may include an opening on the optical axis. The internal space may communicate with an outside environment through the opening. The moving lens group may be exposed to the outside environment through the opening when aligned with the fixed lens group on the optical axis.

The opening may be stopped by a case of the moving lens group when the moving lens group is aligned with the fixed lens group on the optical axis.

The attachable lens module may further include a detachable cover configured to close the opening.

The moving lens group may include two moving lens groups mounted on opposing sides of the fixed lens group.

When the moving lens group is aligned with the fixed lens group on the optical axis, one of the two moving lens groups may be disposed on an object side with respect to the fixed lens group and another one of the two moving lens groups may be disposed on an upper side with respect to the fixed lens group.

An outer surface of the housing may be stepped from a portion where the fixed lens group is positioned toward a portion where the moving lens group is positioned when the moving lens group is not aligned with the fixed lens group on the optical axis.

The moving lens group may be mounted in an area to a side of the fixed lens group.

In another general aspect, an attachable lens module includes: a housing including an internal space; a fixed lens group mounted in the internal space and including a lens aligned on an optical axis of the lens module; and a moving lens group including a moving lens configured to move and mounted in the internal space, wherein the moving lens group is configured to be aligned with the fixed lens group on the optical axis.

The moving lens group may be movable to a position spaced from the optical axis.

Other features and aspects will be apparent from the following detailed description, the drawings, and the claims.

### BRIEF DESCRIPTION OF DRAWINGS

FIG. 1 is a perspective view of a general attachable lens module.

FIG. 2 is a cross-sectional view of FIG. 1.

FIG. 3 is an internal perspective view of an attachable lens module, according to an embodiment.

FIG. 4 is a longitudinal cross-sectional view of the attachable lens module illustrated in FIG. 3.

FIG. 5 is an internal perspective view illustrating a state in which lens groups of the attachable lens module of FIG. 3 are aligned in an optical axis direction.

FIG. 6 is a longitudinal cross-sectional view illustrating the state in which the lens groups of the attachable lens module of FIG. 3 are aligned in the optical axis direction.

FIG. 7 is an internal perspective view of an attachable lens module, according to another embodiment.

FIG. 8 is a longitudinal cross-sectional view of the attachable lens module illustrated in FIG. 7.

FIG. 9 is an exploded perspective view illustrating the manner in which the attachable lens module of FIG. 3 is coupled with a portable terminal, according to an embodiment.

FIG. 10 is a perspective view illustrating the attachable lens module of FIG. 3 coupled with the portable terminal, according to an embodiment.

FIG. 11 is a cross-sectional view taken along the direction A-A′ of FIG. 10.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

Throughout the specification, when an element, such as a layer, region, or substrate, is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween.

As used herein, the term “and/or” includes any one and any combination of any two or more of the associated listed items.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

Spatially relative terms such as “above,” “upper,” “below,” and “lower” may be used herein for ease of description to describe one element's relationship to another element as shown in the figures. Such spatially relative terms are intended to encompass different orientations of the device in use or operation in addition to the orientation depicted in the figures. For example, if the device in the figures is turned over, an element described as being “above” or “upper” relative to another element will then be “below” or “lower” relative to the other element. Thus, the term “above” encompasses both the above and below orientations depending on the spatial orientation of the device. The device may also be oriented in other ways (for example, rotated 90 degrees or at other orientations), and the spatially relative terms used herein are to be interpreted accordingly.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

Due to manufacturing techniques and/or tolerances, variations of the shapes shown in the drawings may occur. Thus, the examples described herein are not limited to the specific shapes shown in the drawings, but include changes in shape that occur during manufacturing.

The features of the examples described herein may be combined in various ways as will be apparent after an understanding of the disclosure of this application. Further, although the examples described herein have a variety of configurations, other configurations are possible as will be apparent after an understanding of the disclosure of this application.

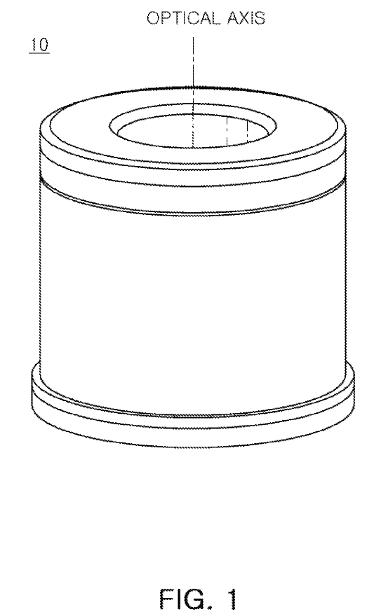

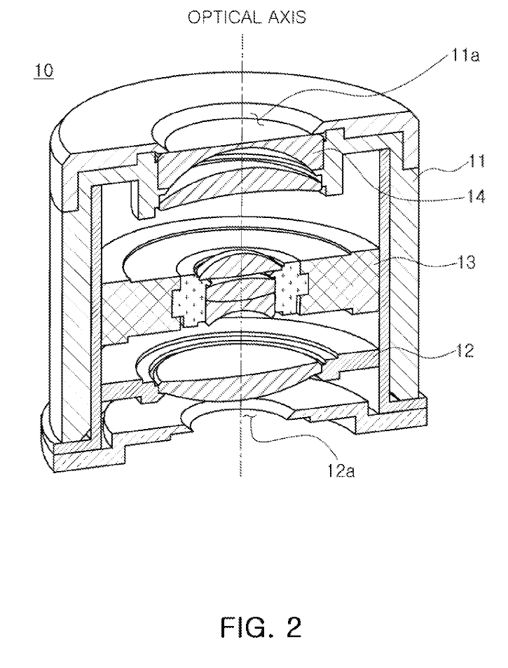

FIG. 1 is a perspective view of a general attachable lens module. FIG. 2 is a cross-sectional view of FIG. 1.

Referring to FIGS. 1 and 2, a generally used attachable lens module 10 is illustrated. As illustrated, the attachable lens module 10 includes a housing 11 having an external form, and including an internal space and first to third lens groups 12, 13, and 14 sequentially stacked in the housing 11 and coaxially aligned on the optical axis of the lens module 10. Each of the lens groups 12, 13 and 14 includes one or more lenses. Further, the housing 11 is includes an object side opening 11a and an upper side (or image side) opening 12a, respectively, in on the optical axis, to receive and emit light in the optical axis direction.

The housing 11 may generally correspond to a barrel and may have an elongated cylindrical shape such that the lens groups 12, 13, and 14 are mounted in the internal space of the housing 11. The housing 11 is formed in a cylindrical shape to increase the convenience of use to a user and to most efficiently utilize the space occupied by a lens.

In this case, the lens groups are stacked in the lens module 10 to increase optical performance, leading to inevitable elongation of the lens module 10 in the optical axis direction, which reduces the convenience to the user by reducing portability of the lens module 10.

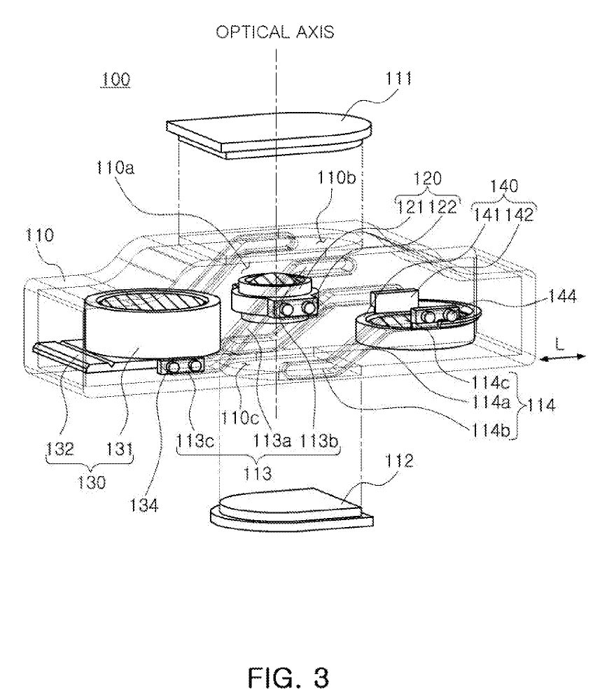

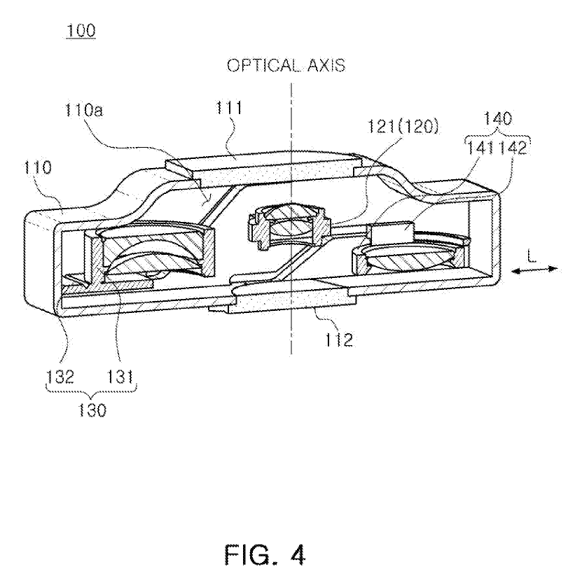

FIG. 3 is an internal perspective view of an attachable lens module 100, according to an embodiment. FIG. 4 is a longitudinal cross-sectional view of the attachable lens module 100.

Referring to FIGS. 3 and 4, the attachable lens module 100 includes a housing 110, having an external form, and including an internal space 110a. The lens module further includes a fixed lens group 120 and moving lens groups 130 and 140. Although one fixed lens group 120 and first and second moving lens groups 130 and 140 are shown and described, more than one fixed lens group may be provided, and one moving lens group or more than two moving lens groups may be provided.

The fixed lens group 120 is fixedly mounted in the internal space 110a of the housing 110 and includes one or more lenses aligned on the optical axis of the lens module 100. The movable lens groups 130 and 140 are mounted in the housing 110 and each include one or more lenses. The first and second movable lens groups 130 and 140 are movable along guide rails 113 and 114, respectively, to be selectively aligned coaxially with the fixed lens group 120 on the optical axis of the lens module 100, or spaced from and in parallel with the optical axis.

The housing 110 may correspond to the barrel, generally accommodating the lens groups 120, 130, and 140 in the internal space 110a. The housing 110 includes a first opening 110b disposed on an object side of the housing 110 and a second opening 110c disposed on an upper side (or image side) of the housing 110 to receive light and emit light via of the lenses in the lens groups 120, 130, and 140. Further, when a user carries the attachable lens module 100, a first cover 111 and a second cover 112 may be provided to cover the first opening 110b and the second opening 110c, respectively. The first cover 111 and the second cover 112 may be formed of a plastic material and may be fixed to the first opening 110b and the second opening 110c, respectively, by a pressing-in scheme or a hook-joining scheme.

When the attachable lens module 100 is not in use to capture images, the fixed lens group 120 and the first and second moving lens groups 130 and 140 may be disposed spaced apart from one another and substantially in parallel to one another in a horizontal direction L perpendicular to the optical axis. The first moving lens group 130 may be disposed on one side of the housing 110, and the second moving lens group 140 may be disposed on another side of the housing 110. A main axis of the first moving lens group 130 and the second moving lens group 140, respectively, may be parallel to the optical axis.

Further, when the attachable lens module 100 is used in combination with a portable camera (such as a digital camera or a portable terminal, the moving lens groups 130 and 140 may be moved within the housing 110 to be coaxially aligned with the fixed lens group 120 along the optical axis.

For this purpose, the fixed lens group 120 is mounted in a fixed position on the optical axis in the internal space 110a of the housing 110, and the housing 110 includes the guide rails 113 and 114 so that the first and second moving lens groups 130 and 140 may move in the internal space 110a of the housing 110.

The fixed lens group 120 may be fixedly provided approximately at a center in a length direction (that is, in the horizontal direction L perpendicular to the optical axis) and the optical axis direction of the housing 110. The first moving lens group 130 moves to the object side with respect to the fixed lens group 120, and the second moving lens group 140 moves to the upper side with respect to the fixed lens group 120, from the state in which the first moving lens group 130, on one side of the housing 110, and the second moving lens group 140, on the other side of the housing 110, are approximately parallel with the fixed lens group 120 in the horizontal direction L.

Accordingly, the housing 110 may have a long and flat shape, so that the fixed lens group 120, approximately at a center of the housing 110 and the first and second moving lens groups 130 and 140, at one side and the other side of the housing 110, may be mounted in the internal space 110a.

Further, the guide rails 113 and 114 provide paths along which the first and second moving lens groups 130 and 140 respectively move in the internal space 110a. The first and second guide rails 113 and 114 may be provided on the one side of the housing 110 and the other side of the housing 110, respectively, so that the guide rails 113 and 114 respectively guide the first and second moving lens groups 130 and 140.

The first and second guide rails 113 and 114 include respective oblique rails 113a and 114a, mounted in a direction inclined with respect to the optical axis, respective first straight rails 113b and 114b connected to the oblique rails 113a and 114a and disposed at positions aligned with respective end portions of the fixed lens group 120 on the optical axis, and respective second straight rails 113c and 114c connected to the oblique rails 113a and 114a at positions spaced from the respective end portions of the fixed lens group 120 in the horizontal direction L, on opposite sides of the fixed lens group 120.

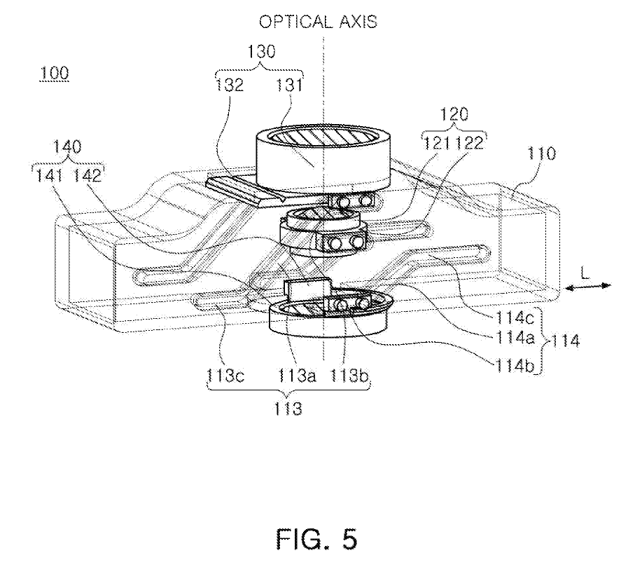

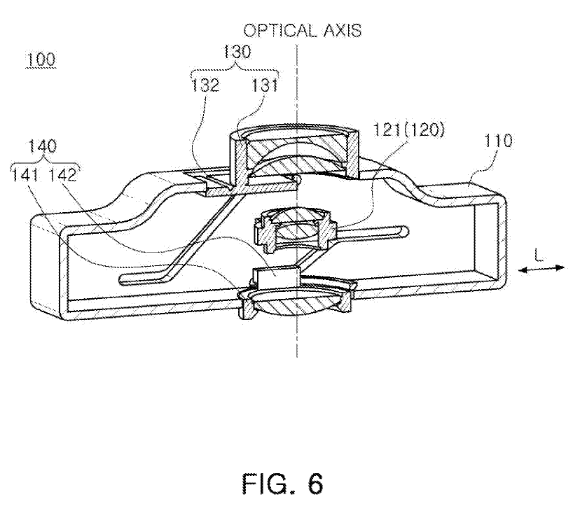

Further, when the first and second moving lens groups 130 and 140 are positioned at the first straight rails 113b and 114b, the first and second moving lens groups 130 and 140 are aligned in parallel with the fixed lens group 120 and the lenses of the first and second moving lens groups 130 and 140, and the lenses of the fixed lens group 120 are coaxially aligned on the optical axis. Further, the internal space 110a communicates with an outside environment of the housing 110 in the optical axis direction through the first and second openings 110b and 110c. When the first and second moving lens groups 130 and 140 are coaxially aligned with the fixed lens group 120 on the optical axis, the first and second moving lens groups 130 and 140 are exposed to the outside environment through the first and second openings 110b and 110c, respectively (see FIGS. 5 and 6).

Therefore, when the first and second moving lens groups 130 and 140 and the fixed lens group 120 are coaxially aligned on the optical axis, the first and second moving lens groups 130 and 140 are exposed to the outside environment, and thus the space utilization of the attachable lens module 100 may be increased. Further, when the attachable lens module 100 is not in use, the first and second moving lens groups 130 and 140 may also enter the internal space 110a of the housing 110 along with the fixed lens group 120, thereby increasing portability of the attachable lens module 100 while preventing the lenses from becoming dirty or dusty. Further, because the housing 110 may have a substantially flat shape, the attachable lens module may be more conveniently carried in comparison to the lens barrel of known lens modules, which have a rounded cylindrical shape.

Further, when positioned at the second straight rails 113c and 114c, the first and second moving lens groups 130 and 140 are aligned in parallel with the fixed lens group 120. That is, the first and second moving lens groups 130 and 140 are spaced apart in the horizontal direction L and aligned in parallel with each other in the horizontal direction L.

The first and second guide rails 113 and 114 may be mounted on an inner side surface of the housing 110 in a groove shape. That is, the first and second guide rails 113 and 114 may include grooves. The first and second moving lens groups 130 and 140 may respectively include protrusion-shaped first and second moving guide parts 134 and 144 that move while respectively fitted in the grooves of the first and second guide rails 113 and 114.

Further, the first and second guide rails 113 and 114 may not be limited to the foregoing shape, but may be mounted on the inner side surface of the housing 110 in a protrusion shape. In such an example, the first and second moving lens groups 130 and 140 may each include a moving guide part (not illustrated) that is mounted in a movable groove, and the protrusion-shaped first and second guide rails 113 and 114 may be fitted in the grooves.

The first and second moving lens groups 130 and 140 include first and second lens barrels 131 and 141, respectively, in which one or more lenses are disposed, and first and second cases 132 and 142, respectively mounted in the first and second lens barrels 131 and 142 and stopping the first and second openings 110b and 110c when the first and second lens groups 130 and 140 are coaxially aligned with the fixed lens group 120 on the optical axis. Further, the first and second cases 132 and 142 may include the first and second moving guide parts 134 and 144, which are guided in the first and second guide rails 113 and 114, respectively.

When coaxially aligned with the fixed lens group 120 on the optical axis, the first and second cases 132 and 142 may be biased to the fixed lens group 120 and the first and second lens barrels 131 and 141 may be exposed to the outside environment through the first and second openings 110b and 110c.

Further, the fixed lens group 120 includes a lens barrel 121 including one or more lenses disposed therein, and a connection 122 mounted in the lens barrel 121 and fixed to the housing 110. The connection 122 may have a protrusion shape that is fitted in a groove that is mounted in the housing 110.

Further, an outer surface of the housing 110 may be stepped from a portion where the fixed lens group 120 is provided toward portions where the first and second moving lens groups 130 and 140 are positioned when the first and second moving lens groups 130 and 140 are not aligned with the fixed lens group 120 on the optical axis. This configuration reduces a size of the housing 110 while utilizing the space of the housing 110 as much as possible, in consideration of a moving path of the first and second moving lens groups 130 and 140 along the first and second guide rails 113 and 114, respectively.

Further, a moving pin (not illustrated), that may be operated manually, may be exposed to the outside environment to move the first and second moving lens groups 130 and 140 along the first and second guide rails 113 and 114 in the housing 110. The moving pin may be mounted in the first and second cases 132 and 142 of the first and second moving lens groups 130 and 140, respectively. For instance, the moving pin may be mounted in the first and second moving guide parts 134 and 144, respectively.

FIG. 5 is an internal perspective view illustrating a state in which the lens groups 120, 130, and 140 of the attachable lens module 100 are coaxially aligned on the optical axis. FIG. 6 is a longitudinal cross-sectional view of the attachable lens module 100, illustrating the state in which the lens groups 120, 130, and 140 are coaxially aligned on the optical axis.

FIGS. 5 and 6 illustrate the state in which the first and second moving lens groups 130 and 140 in the attachable lens module 100, have moved along the first and second guide rails 113 and 114 to be coaxially aligned with the fixed lens group 120 on the optical axis. The first and second moving lens groups 130 and 140 in the internal space 110a of the housing 110 are exposed to the outside environment through the first and second openings 110b and 110c, respectively, before being coaxially aligned on the optical axis. Further, the first and second moving lens groups 130 and 140 may move manually or automatically and may move by means of various types of instruments.

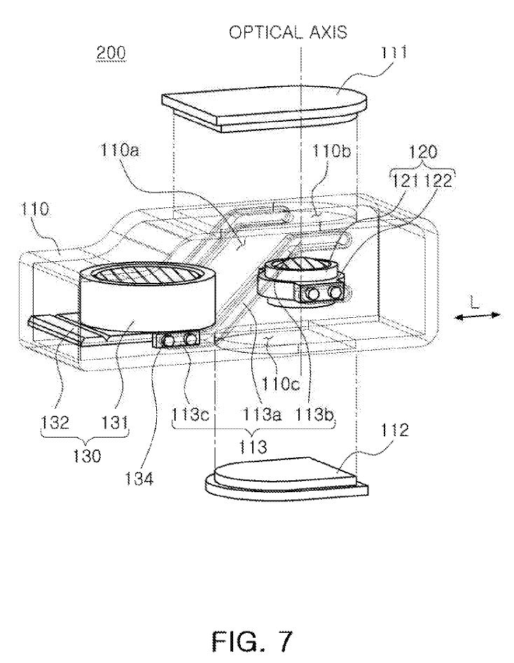

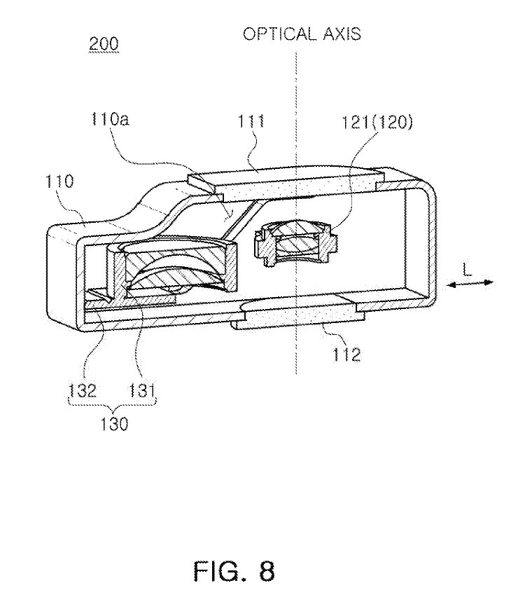

FIG. 7 is an internal perspective view of the attachable lens module 200, according to another embodiment. FIG. 8 is a longitudinal cross-sectional view of the attachable lens module 200. The attachable lens module 200 includes one fixed lens group 120 and one moving lens group 130. More specifically, FIGS. 7 and 8 show an example in which the moving lens group 130 in the attachable lens module 200 is movable to the object side of the housing 110 in a manner similar to that described with respect to the embodiment of FIGS. 3 through 6. Other components of the attachable lens module 200, with the exception of the exclusion of the moving lens group 140, are the same as those included in the attachable lens module 100 of FIGS. 3-6. Therefore, a detailed description of the other components in the attachable lens module 200 will be omitted.

However, the disclosure is not limited to the embodiment of FIGS. 7 and 8. For example, the attachable lens module 200 may alternatively include the fixed lens group 120 and, instead of the moving lens group 130, one moving lens group 140 (see FIGS. 3 through 6), which is disposed at the other side of the housing 110 and is movable to the upper side of the housing 110.

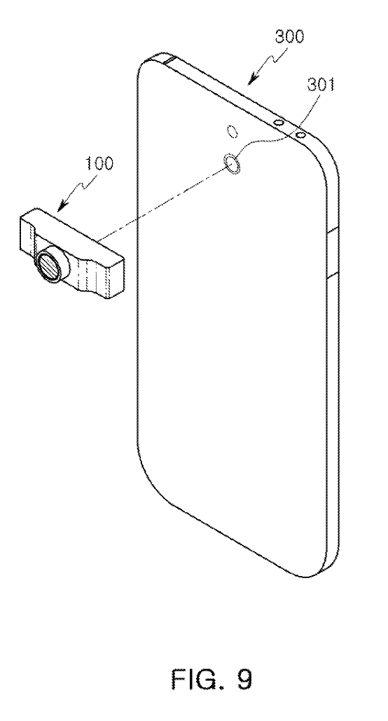

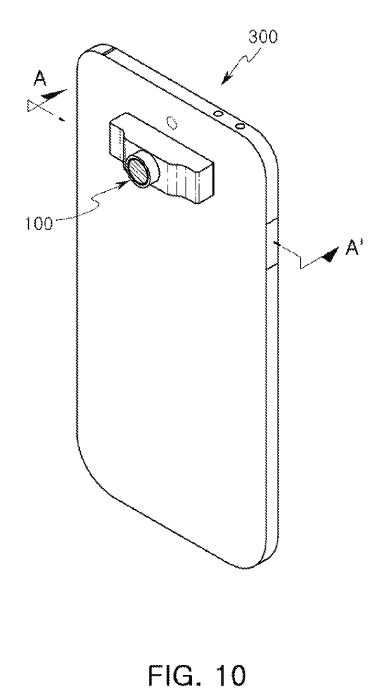

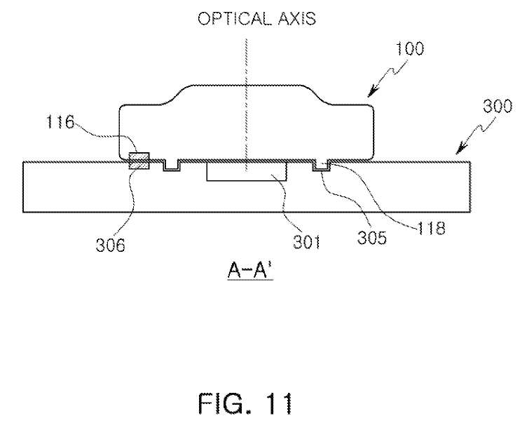

FIG. 9 is an exploded perspective view illustrating the manner in which the attachable lens module 100 is coupled with a portable terminal 300, according to an embodiment. FIG. 10 is a perspective view illustrating the attachable lens module 100 coupled with the portable terminal 300, according to an embodiment. FIG. 11 is a cross-sectional view taken along direction A-A′ of FIG. 10. It should be understood that, although FIGS. 9-11 and the following description reference the attachable lens module 100, FIGS. 9-11 and the following description also apply to the attachable lens module 200.

Referring to FIGS. 9-11, the attachable lens module 100 may be coupled with the portable terminal 300 by a clamp, a ring, a hook, a magnet, or another fastening element. FIGS. 9 and 11 illustrate an example in which the attachable lens module 100 is fixed to the portable terminal 300 by a magnet.

In the illustrated example, the housing 110 of the attachable lens module 100 includes a magnet 116, and the portable terminal 300 includes a magnet or a metal part 306. When the case of the portable terminal 300 is formed of metal, the separate magnet or metal member 306 may not be provided. Further, in another embodiment, the attachable lens module 100 may include the magnet or metal part 306 and the portable terminal 300 may include the magnet 116.

Further, the attachable lens module 100 and a camera module 301 of the portable terminal 300 need to be accurately aligned on the optical axis/in the optical axis direction, and therefore a component to guide the alignment may be required. Accordingly, the housing 110 includes two or more protrusion-shaped positioning guides 118 and the portable terminal 300 includes two or more groove-shaped positioning guides 305 in which the positioning guides 118 may be fitted.

As set forth above, according to the disclosed embodiments, an attachable lens module may be conveniently carried by a user while providing sufficient optical performance. Further, the lens groups of the attachable lens module may move to positions in which the lens groups are aligned in parallel with each other in a horizontal direction when the attachable lens module is not in use, such that the space required for the lens module may be reduced. Additionally, when the attachable lens module is not used, the attachable lens module may have a relatively flat exterior form, thereby increasing the portable convenience to the user.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. An attachable lens module, comprising:
a housing comprising an internal space;
a fixed lens group mounted in the internal space and comprising a lens aligned on an optical axis of the lens module; and
a moving lens group comprising a moving lens, and configured to move along a guide rail mounted in the housing to be aligned with the fixed lens group on the optical axis.

2. The attachable lens module of claim 1, wherein the moving lens group is configured to move from a position in which the moving lens group is horizontally spaced from the fixed lens group to a position in which the moving lens group is disposed on the optical axis.

3. The attachable lens module of claim 1, wherein the moving lens group is configured to move in one of an object side direction of the fixed lens group and an upper side direction of the fixed lens group, from a position in which the moving lens group is horizontally spaced from the fixed lens group, to be aligned with the fixed lens group on the optical axis.

4. The attachable lens module of claim 1, wherein:
the guide rail comprises an oblique rail disposed in a direction inclined with respect to the optical axis; and
the moving lens group is configured to move from a position in which the moving lens group is horizontally spaced from the fixed lens group to a position in which the moving lens group is aligned with the fixed lens group on the optical axis.

5. The attachable lens module of claim 4, wherein:
the guide rail comprises a first straight rail connected to the oblique rail at a position aligned with an end portion of the fixed lens group; and
the moving lens group is aligned in parallel with the fixed lens group when positioned at the first straight rail.

6. The attachable lens module of claim 5, wherein:
the guide rail further comprises a second straight rail connected to the oblique rail at a position spaced from the end portion of the fixed lens group in a horizontal direction perpendicular to the optical axis; and
the moving lens group is aligned in parallel with the fixed lens group when positioned at the straight rail.

7. The attachable lens module of claim 1, wherein:
the guide rail is mounted on an inner side surface of the housing and comprises a groove; and
the moving lens group comprises a protrusion-shaped moving guide part configured to move while fitted in the guide rail.

8. The attachable lens module of claim 1, wherein:
the guide rail is mounted on an inner side surface of the housing in a protrusion shape; and
the moving lens group comprises a moving guide part mounted in a groove configured to move while the guide rail is fitted in the groove.

9. The attachable lens module of claim 1, wherein:
the housing comprises an opening on the optical axis;
the internal space communicates with an outside environment through the opening; and
the moving lens group is exposed to the outside environment through the opening when aligned with the fixed lens group on the optical axis.

10. The attachable lens module of claim 9, wherein the opening is stopped by a case of the moving lens group when the moving lens group is aligned with the fixed lens group on the optical axis.

11. The attachable lens module of claim 9, further comprising a detachable cover configured to close the opening.

12. The attachable lens module of claim 11, wherein the moving lens group comprises two moving lens groups mounted on opposing sides of the fixed lens group.

13. The attachable lens module of claim 12, wherein when the moving lens group is aligned with the fixed lens group on the optical axis, one of the two moving lens groups is disposed on an object side with respect to the fixed lens group and another one of the two moving lens groups is disposed on an upper side with respect to the fixed lens group.

14. The attachable lens module of claim 1, wherein an outer surface of the housing is stepped from a portion where the fixed lens group is positioned toward a portion where the moving lens group is positioned when the moving lens group is not aligned with the fixed lens group on the optical axis.

15. The attachable lens module of claim 1, wherein the moving lens group is mounted in an area to a side of the fixed lens group.

16. An attachable lens module, comprising:
a housing comprising an internal space;
a fixed lens group mounted in the internal space and comprising a lens aligned on an optical axis of the lens module; and
a moving lens group comprising a moving lens configured to move and mounted in the internal space, wherein the moving lens group is configured to be aligned with the fixed lens group on the optical axis.

17. The attachable lens module of claim 16, wherein the moving lens group is movable to a position spaced from the optical axis.
